(19) United States
(12) Patent Application Publication
(10) Pub. No.: US 2004/0128364 A1
(43) Pub. Date: Jul. 1, 2004

(54) Secured internet media player

(76) Inventor: James R Clark, Aurora, CO (US)

Correspondence Address: Ken J Pedersen, Pedersen & Company, PO Box 2666, Boise, ID, 83701-2666, US

(21) Appl. No.: 10/296,015

(22) PCT Filed: May 12, 2001
(86) PCT No.: PCT/US01/15339

(51) Int. Cl. G06F 15/16

(52) U.S. Cl. 709/219

(57) ABSTRACT

The present invention provides on-line servers (4) and (4′) and databases (1) and (1′) operated by a media service providing operation across the Internet. These services are used by customers who purchase Media Player unit (6), and then access the servers (4) and (4′) by, for example, direct modem (5) dial-up via free access telephone numbers (9). By using the invented equipment and systems, secure access and secure downloading of audio and music content is done, such that each user can pick their own listening collections, while the media service provider can maintain copyright protection security.

### BACKGROUND OF THE INVENTION

1. Field of the Invention

Embodiments of the present invention relate to MP3 type digitally encoded audio systems.

As an introduction to the problems solved by the present invention, consider the development of present-day MP3 type players. MP3 technology allows users to download free audio and music content over the Internet for play on MP3 compatible playing devices, including those that are portable and those internal to a personal computer. From the point of view of the audio and music content recording industry, a major drawback to the presently available MP3 devices and technologies is that they afford virtually no protection against copyright infringements by either Internet MP3 sourcing parties, nor by MP3 end users. The present invention remedies this functional deficiency through a novel and innovative process for controlling access to media content.

### SUMMARY OF THE INVENTION

The present invention relates to on-line servers and databases operated by a media service providing operation across the Internet. These services are used by customers who purchase Media Player units, which may be embodied in portable players or fixed-base PC's. These customers access the servers, for example, by direct modem dial-up via free access (800 style) telephone numbers. Secure access and secure downloading of audio and music content is achieved, such that each user can pick their own listening collections, and the provider can maintain copyright protection security.

Accordingly, according to the present invention, each Media Player unit's built-in modem provides transfer of the audio and music content from a private world-web site, only accessible from a registered Media Player unit that is an embodiment of the present invention. The control given by this restricted accessibility provides a cost effective solution to the legal problems that have recently arisen from unauthorized distribution of copyright protected audio and music content over the Internet.

Another aspect of the present invention gives customers great flexibility in the selection and use of the audio and music content, while at the same time keeping the overall costs to the user or buyer of audio content reasonably low. The complete integrated approach provided by the present invention will allow media service companies to expand their marketing of content while ensuring maximum protection of and revenue from their libraries.

Another aspect of this invention is the incorporation of a unique serial number for each Media Player unit. This number is registered with the system web site through which access to the audio and music content is given, along with the customer credit card or other means of billing fees (i.e. direct electronic transfer from checking accounts, etc.).

Once the user is registered, the then-operational Media Player unit can be used to access servers, which give access to audio and music content libraries, on a per title bases. Pre-selected portions of titles may be made available for free listening by prior arrangements with audio and music content providers. Once titles are selected for downloading, corresponding charges are made to the customer's account. Each account is billed to the pre-arranged credit card on a monthly basis.

Another aspect of this invention is that the Media Player will have neither output ports nor removable memory chips in order to prevent digital copying. This aspect protects against copyright infringement. The fees for downloading will be low (i.e. 25 cents per title) due to the low cost of conveying the song to the customer. This low cost will be seen as a valuable feature by the end user. At the same time, copyright rights are protected and the artists and recording companies can collect negotiated fees on a per title basis.

These and other embodiments, aspects, advantages and features of the present invention will be set forth in part in the description, and in part will come to those skilled in the art by reference to the following description of the invention and referenced drawings, or by practice of the invention.

### BRIEF DESCRIPTION OF THE DRAWINGS

FIG. 1 is a schematic diagram of the inter-networked system components according to one embodiment of the invention.

FIG. 2 is a flowchart of the initial Media Player registration process according to one embodiment of the invention.

### DETAILED DESCRIPTION OF THE INVENTION

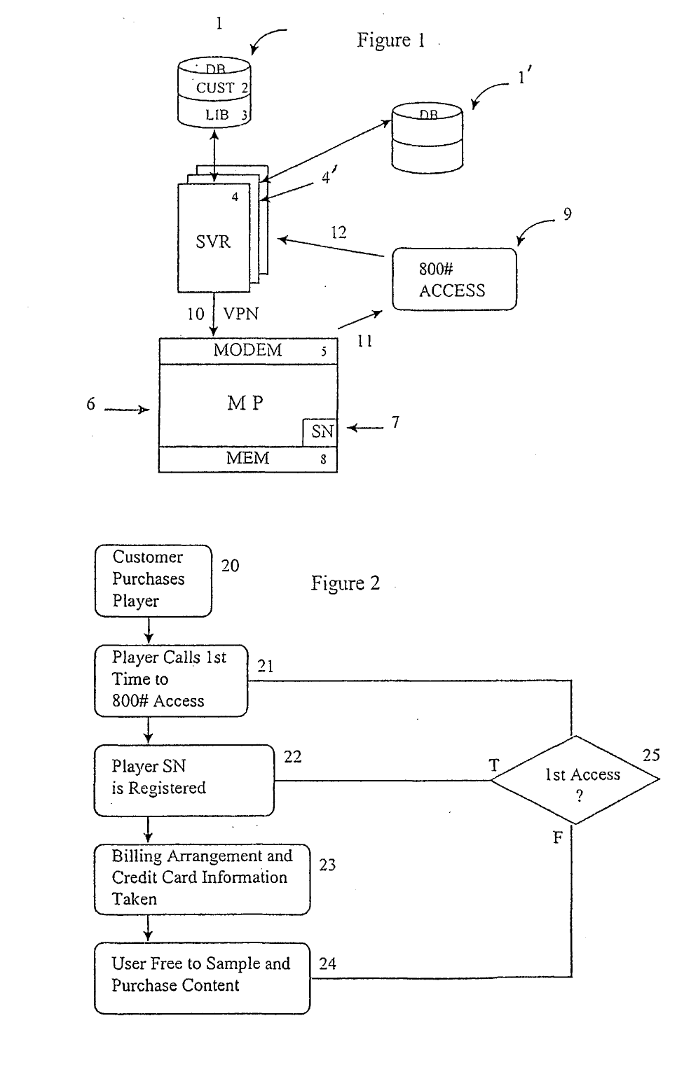

FIG. 1 is a schematic diagram of the inter-networked system components. The representative system databases 1 and 1′ are connected to individual representative servers 4 and 4′. Each database 1 and 1′ may contain customer data 2 and/or library data 3. Servers 4 and 4′ may be on-line on the Internet, or on a local area network (LAN), etc. Each of these servers 4 and 4′ has a network interface. The typical Media Player unit 6 contains a dial-up modem 5, a unique serial number 7, and storage memory 8. Player 6, when connected via telephone line 11, is capable of, automatically upon command, dialing a free access number service 9 that is exclusively available to, and particularly caters to, the Media Player unit described herein, and no other types of players. Once the Player 6 is validated as a registered device in current good standing, then requests for media sampling and/or download from Player 6 can be serviced via the access service 9. Serial number 7 may be any unique code or identifier. Any data, either customer data 2 or library content 3, can be accessed by the access service 9 via network link 12 to a server 4 and database 1. Library content 3 may include, for example, audio and music content. If download requests are made on behalf of a player 6 via the access service 9, then encrypted download information can be sent from a server 4 directly to a particular requesting Media Player 6 over encrypted link 10. Encrypted link 10 may be a conventional Internet/network link. This way, unique serial number 7 from Media Player unit 6 is the public/private key for encrypted link 10. Also, this way, the requesting Media Player can receive and store the download information for playback.

FIG. 2 depicts a flowchart of the Media Player registration process. When a Media Player is first purchased 20, it may have some promotional or instructional content, which is factory loaded. The Player is not at first, however, capable of accessing media selections over the private access world-wide-web site. By simply connecting the Media Player 6 to any telephone jack and selecting the connection mode, the Player will dial a free access number 21. Once connection is established,- the access service will discover that this is a first time call 25. The registration process will then continue, whereby the access service registers the unit serial number 22 along with the user's billing information and other required personal information 23. Once registered, the Media Player can be used freely within the conditions established by the service provider for sampling and usage of titles, groups of titles, other content, or other promotional schemes. This way, after registration, the user is free to sample and purchase content from the server 4 simply by dialing in access to, and requesting titles from, access service 9.

The benefits that will be attained through the use of the present invention are multiple. For the end customer, this system provides legal access control to copyrighted music, for a low cost and also it gives great flexibility in content selection. For the recording industry, this invention provides a direct low cost Internet distribution capability that protects copyrighted music and derives a steady income stream. It completely prevents digital copying. It also provides the capability to introduce and promote new artists with small followings with minimal cost.

For the service providing company, multiple income streams can be realized through patent licensing fees, fees per title, advertising fees on the world-wide-web site and Media Player manufacturing profits. The service provider will also gain an ability to promote its own and new artists in a cost-effective manner.

Although this invention has been described above with reference to particular means, materials and embodiments, it is to be understood that the invention is not limited to these disclosed particulars, but extends instead to all equivalents within the scope of the following claims.

I claim:

1. A media player unit with a unique identifier, for the individual media player unit only, that is registered with an on-line server and a database, and enabled by said unique identifier to receive data from said server and database, said media player unit not having a copy output port and not having a removable memory chip.

2. The player unit of claim 1 with also a dial-up modem and storage memory.

3. An MP3 type media player with a unique serial number, for the individual MP3 type media player only, that is registered with an Internet website, and enabled by said unique serial number to receive media content from said Internet website, said media player unit not having a copy output port and not having a removable memory chip.

4. The media player of claim 3 with also a dial-up modem and storage memory.

5. A secured network, comprising:
an on-line server and a database available to said server;
an encrypted link from said server to a media player;
said media player having a dial-up modem and a unique identifier for the individual media player only; and
an access service available to said dial-up modem, and enabled by said unique identifier to permit said on-line server to transmit data via said encrypted link to said media player;
wherein said media player unit does not have a copy output port and does not have a removable memory chip.

6. The network of claim 5 wherein said media player also has storage memory.

7. A secured Internet media system, comprising:
the Internet with an on-line server and a media database available to said server;
an encrypted link from said server to a media player;
said media player having a dial-up modem, a unique identifier for the individual media player only, and storage memory; and
an access service available to said dial-up modem, and enabled by said unique identifier to permit said on-line server to transfer media content from said media database via said encrypted link to said media player;
wherein said media player unit does not have a copy output port and does not have a removable memory chip.

8. The media system of claim 7 wherein the media database also contains customer data.

9. The media system of claim 7 wherein said access service is a free access (800 style) telephone connection.

10. A media player registration process, comprising:
not enabling a media player to access media selections from a network;
connecting said media player to an access service;
registering a unique identifier and customer information for the individual media player only through said access service; and
enabling said media player to access media selections from a network with said registered unique identifier;
wherein said media player unit does not have a copy output port and does not have a removable memory chip.

11. The registration process of claim 10 wherein the network is the Internet.

12. The registration process of claim 10 wherein access service is a free access (800 style) telephone connection.

13. The registration process of claim 10 wherein the customer is charged for downloaded selections.
